(19) United States
(12) Patent Application Publication
(10) Pub. No.: US 2006/0226220 A1
(43) Pub. Date: Oct. 12, 2006

(54) Sales office system

(76) Inventors: Atsushi Hasegawa, Tokyo (JP); Akihito Itou, Yokohama (JP); Masahiro Abe, Yokohama (JP); Kazuma Kurata, Tokyo (JP); Masataka Itakura, Yokohama (JP); Toshiyuki Tsutsui, Tokyo (JP); Takeshi Minemoto, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/271,769

(22) Filed: Nov. 14, 2005

(30) Foreign Application Priority Data
Apr. 8, 2005 (JP) 2005-111512

(51) Int. Cl. G06K 15/00

(52) U.S. Cl. 235/383

(57) ABSTRACT

A sales office system acquires information about a customer's attention to financial commodities without demanding special operations from the customer and provides effective information matching the acquired customer's attention. In the sales office system that connects with plural information processors via networks, a sales office system server includes a part that cooperates with an Internet banking server, a part that cooperates with a customer management server, a part that acquires dealing statuses, a part that acquires consultation reservation information, a part that acquires commodity information, a part that determines valuable information by valuable information criteria, and a part that holds customers' operation histories, and effective sales are performed for customers by flexibly and effectively using information about purchasers of a variety of commodities.

### CROSS-REFERENCE TO RELATED APPLICATION

The present application claims priority from Japanese application JP 2005-111512 filed on Apr. 8, 2005, the content of which is hereby incorporated by reference into this application.

### BACKGROUND OF THE INVENTION

The present invention relates to a sales office system that conducts transactions by using plural information processors in a sales office and outside the sales office.

A conventional sales office system has performed processing described below as disclosed in Patent Reference 1 (JP-A No. 2002-91780). By interlinking-terminals of a financial institute with each other, to display information suitable for each customer according to the types of the terminals, a display content command table corresponding to the terminals is provided for each customer, steps of commodity information are managed on the table, and the next step of the commodity information is updated by input information from a customer's terminal and information on a customer table.

Also, as disclosed in Patent Reference 2 (JP-A No. 2004-265289), a conventional sales office system has performed processing described below. A terminal operated by customers is placed in a store front and questionnaires are presented to the customers. By allowing the customers to operate the terminal and fill out the questionnaires, personal information about the customers and interest information on commodities are acquired to use them for sales in the store.

Furthermore, as disclosed in Patent Reference 3 (JP-A No. 2004-157704), for visiting customers, a processing flow is decided depending on visiting purposes, customer information, and a congestion degree of a sales office to realize effective services for the customers.

### SUMMARY OF THE INVENTION

However, the prior art described in Patent Reference 1 manages steps of commodity information to be displayed for each customer and displays commodity information suitable for the steps on a customer-operated information processor. Therefore, different information is only displayed for any customer, and effective information provision with customers' attention to financial commodities in mind, such as commodities shown differently between interested customers and uninterested customers, is not achieved.

When a customer operates the information processor, he (she) can refer to commodity information displayed. However, action is stopped there, and it is difficult to advance control to the next step of sales to the customer.

There are currently an increasing number of information processors by which plural customers refer to public space at overlapping timings. Sales activity by the information processors is expected to become brisk.

The prior art described in Patent Reference 2 demands from customers an operation for sales in a sales office such as a reply to questionnaires, incurring the risk of giving discomfort to the customers or the risk of the customers' rejecting a reply to the questionnaires.

The prior art described in Patent Reference 3 gives no consideration to an individual's attention phase although a degree of congestion is taken into account.

Future sales office systems will be required to effectively acquire customer information and present commodity information by using various information processors, with the attributes and attention phases of individual customers in mind.

An object of the present invention is to provide a system and the like that, by setting three phases notice, understanding, and consent for each customer as attention phases for commodity knowledge and managing the flow of the phases by customer action, can perform effective sales matching customers' attention phases for financial commodities.

An object of the present invention is to provide a system and the like that, when a customer is interested in commodity information provided by a financial institute, prompt the customer to take action and smoothly guide the customer to a next phase, thereby can improve the customer's convenience and effectively perform sales of the financial institute.

An object of the present invention is to provide a system and the like that, by allowing information processors placed in public space outside a sales office to utilize personal information inputted to other personal information processors, can perform sales effective for plural customers in the public space at the same time, wherein the information processors placed in public space are those that plural persons can view information outputted from them at overlapping timings.

An object of the present invention is to provide a system that can show commodities appropriate to customers visiting a sales office to the customers from the sales office in a natural flow without demanding a special operation from the customers.

To solve the above-mentioned objects, the present invention provides plural statuses of commodity information for purchasers and performs information processing for commodity provision corresponding to the statuses. The statuses include notice, understanding, and content. The present invention acquires histories of purchasers' operations on terminals placed in a sales office and makes reference to customers' operation histories by office clerks. A more detailed construction is described below.

A sales office system of the present invention connects via a network with plural types of information processors operated by purchasers of commodities (hereinafter referred to as customers) or office clerks, a sales office including plural information processors, and a sales office system server that is accessed by operations from the information processors in the sales office and has functions for performing various processing. The sales office system server connects via a network with an Internet banking server accessed from information processors placed outside the sales office, and a customer management server that manages customer information. The sales office system server includes a part that cooperates with the Internet banking server, a part that cooperates with the customer management server, a part that acquires dealing statuses, a part that acquires consultation reservation information, a part that acquires commodity information, a part that determines valuable information by valuable information criteria, and a part that acquires operation histories in the information processor operated by the customer that is installed in the sales office. The sales office system server includes: means for presenting summary information describing a summary of a commodity to a purchaser of the commodity via information processors; means for accepting input from the purchaser in response to the presented summary information; means for storing an identifier for identifying the purchaser and a flag indicating that the purchaser noticed the commodity with a correspondence between them; means for presenting detailed information of the commodity to the purchaser in response to the input from the purchaser; means for accepting input of consideration to purchasing a commodity from the purchaser; and means for storing the identifier and a consideration flag with a correspondence between them, thereby advising a purchaser marked with the consideration flag to purchase the commodity.

The sales office system server includes: a status in which the customer is invited to have interest in a commodity or a commodity in which the customer is interested is identified; a status in which more detailed information about a commodity in which the customer is interested is provided to the customer to aid the customer in deepening understanding of the commodity; and a status in which the customer who has understood the commodity is supplied with information useful for the customer to judge whether the commodity is appropriate to the customer as against a customer's present situation, to support the judgment.

The sales office system server transitions among the statuses based on information inputted from the information processors operated by the customer, information inputted from the information processors placed in the sales office, and information about the customer that is stored in a table or the like in the sales office system.

The sales office system server has means by which office clerks refer to information inputted from the information processors operated by the customer, information inputted from the information processors placed in the sales office, and information about the customer that is stored in a table or the like in the sales office system.

According to the present invention, in dealings using a sales office system and information processors, by flexibly and efficiently using various customer information, sales effective for customers can be performed.

### BRIEF DESCRIPTION OF THE DRAWINGS

FIG. 1 is a drawing of a network configuration including a sales office system and information processors in this embodiment;

FIG. 2 is a drawing showing an example of a customer information table for Internet banking in this embodiment;

FIG. 3 is a drawing showing an example of a customer information table in this embodiment;

FIG. 4 is a drawing showing an example of a dealing status table in this embodiment;

FIG. 5 is a drawing showing an example of a consultation reservation information table in this embodiment;

FIG. 6 is a drawing showing an example of a commodity information table in this embodiment;

FIG. 7 is a drawing showing an example of a valuable information criterion table in this embodiment;

FIG. 8 is a drawing showing the flow of ATM control in a method of controlling a sales office system and processors in this embodiment;

FIG. 9 is a drawing showing a customer-specific valuable information decision flow in the method of controlling a sales office system and information processors in this embodiment;

FIG. 10 is a drawing showing a general flow of Internet banking control in the method of controlling a sales office system and information processors in this embodiment flow;

FIG. 11 is a drawing showing an example 1 of an ATM screen in this embodiment;

FIG. 12 is a drawing showing an example 2 of the ATM screen in this embodiment;

FIG. 13 is a drawing showing an example 3 of the ATM screen in this embodiment;

FIG. 14 is a drawing showing an example 4 of the ATM screen in this embodiment;

FIG. 15 is a drawing showing an example of a information display unit screen in this embodiment;

FIG. 16 is a drawing showing an example of an information table screen in this embodiment;

FIG. 17 is a drawing showing an example 1 of an Internet banking screen in this embodiment;

FIG. 18 is a drawing showing an example 2 of the Internet banking screen in this embodiment;

FIG. 19 is a drawing showing an example 3 of the Internet banking screen in this embodiment;

FIG. 20 is a drawing showing an example 4 of the Internet banking screen in this embodiment;

FIG. 21 is a drawing showing an example of a temporary customer operation history table in this embodiment;

FIG. 22 is a drawing showing customer operation history acquisition in the method of controlling a sales office system and information processors in this embodiment;

FIG. 23 is a drawing showing a general flow of dealing switching processing based on a customer operation history in the method of controlling a sales office system and information processors in this embodiment;

FIG. 24 is a drawing showing an example 1 of an information/consultation terminal screen in this embodiment;

FIG. 25 is a drawing showing an example 2 of the information/consultation terminal screen in this embodiment;

FIG. 26 is a drawing showing an example 1 of a window terminal screen in this embodiment;

FIG. 27 is a drawing showing an example 2 of the window terminal screen in this embodiment; and

FIG. 28 is a drawing showing an example 3 of the window terminal screen in this embodiment.

### DESCRIPTION OF THE PREFERRED EMBODIMENTS

Hereinafter, embodiments of the present invention will be described.

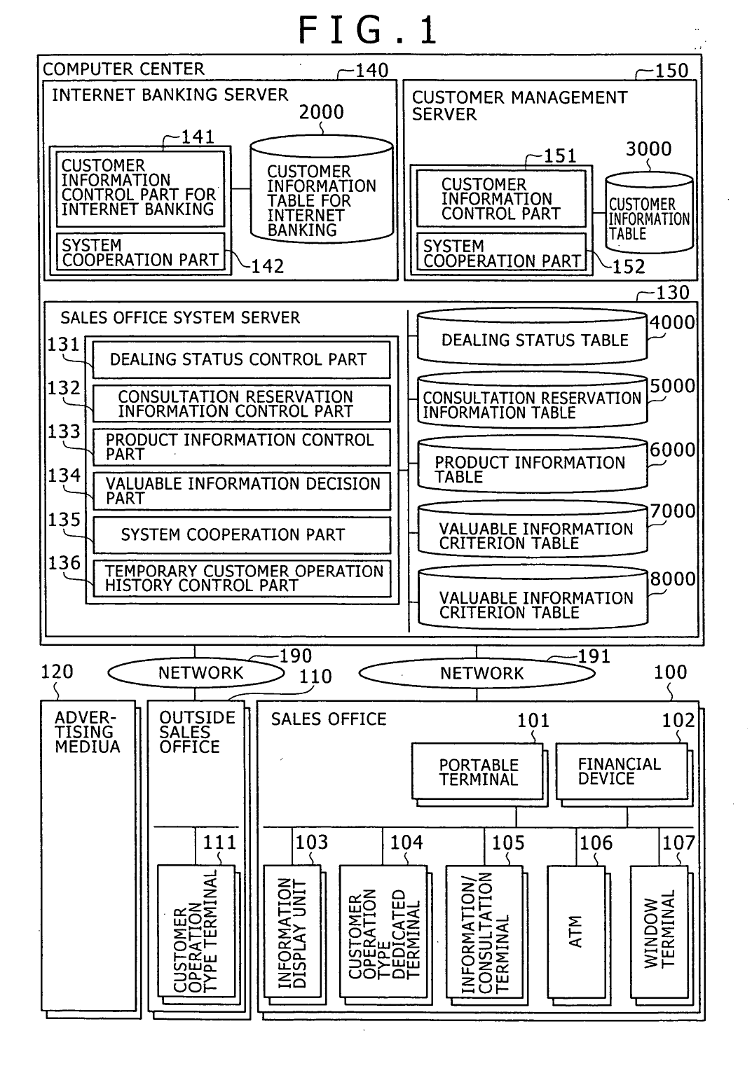

FIG. 1 is a drawing showing a system configuration of the present invention. As shown in FIG. 1, the system includes portable terminals 101, financial devices 102, information display units 103, customer operation type dedicated terminals 104, information/consultation terminals 105, ATMs 106, window terminals 107, and the like in a sales office 100, a terminal group such as customer operation type terminals 111 outside a sales office 110, advertising media 120, and a server group including a sales office system server 130, an Internet banking server 140, and a customer management server 150. The terminals in the sales office 100 are connected with the server group through a network 191, and the terminals outside the sales office 110 are connected with the server group through the network 190. The network 191 is a proper network, and the network 190 assumes the Internet. However, the types of networks used are free.

The sales office system server 130 presumes what commodity information customers currently need, or what commodity information customers are currently interested in. It includes a valuable information decision part 134 that decides commodity information presented to customers, an information control parts that holds and manages various information, and a system cooperation part 135 that cooperates with other systems.

The sales office 100 includes the portable terminals 101, the financial devices 102, the information display units 103 that display a specified video, the customer operation type dedicated terminals 104 by which a visiting customer inputs information by himself (herself) to perform dealings, the information/consultation terminals 105 by which the customer can perform Internet banking, and search for and browse bank and commodity information in the sales office 100, the ATMs 106, and the window terminals 107 that a bank clerk operates during direct communication with a customer at a window.

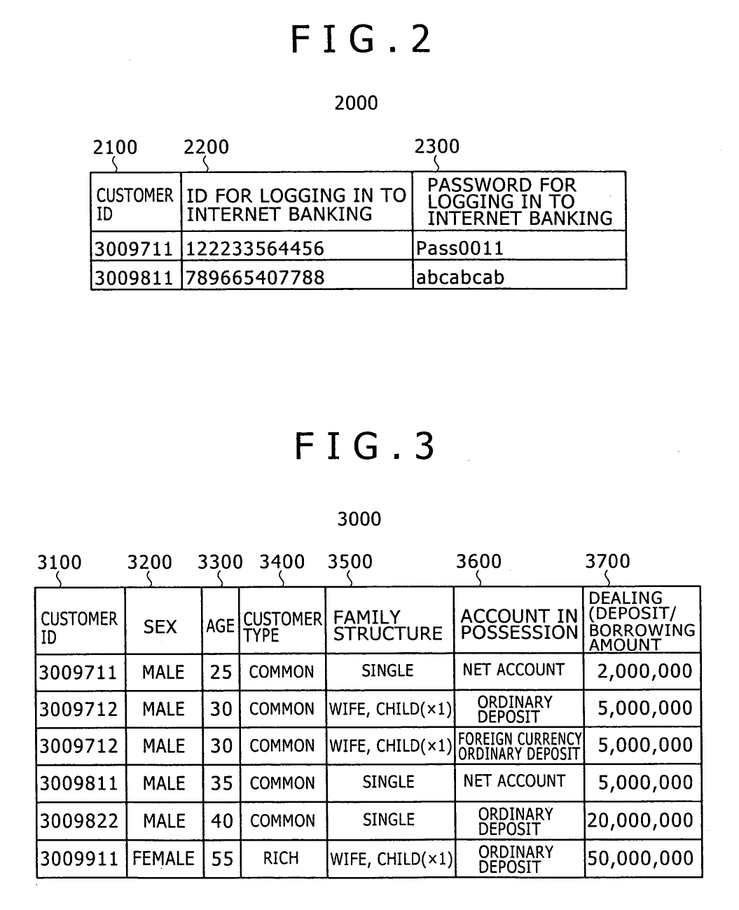

The financial device refers to special peripheral devices such as a bankbook printer and ATM. With reference to FIGS. 2 to 7, various tables used in the present invention will be described.

FIG. 2 shows a customer information table for Internet banking 2000 used for customer authentication in Internet banking. It includes customer ID 2100, ID 2200 for logging in to Internet banking, and password for logging in to Internet banking 2300. In this embodiment, this table is managed by a customer information control part for Internet banking 141 in the Internet banking server 140. However, it may be constructed to be changeable so as to be managed by any server.

FIG. 3 shows a customer information table 3000 that manages various information about customers and is used to be reflected in the decision of valuable information. It includes customer ID 3100, sex 3200, age 3300, customer type 3400, family structure 3500, account in possession 3600, and dealing (deposit/borrowing) amount 3700. Valuable information is information presumed to be necessary to customers or information presumed to be interesting to customers. Although, in this embodiment, this table is managed by the customer information control part 151 in the customer management server 150, by which server it is managed may be freely changed. Items other than the customer ID 3100 of this table may be freely changed depending on customer information required.

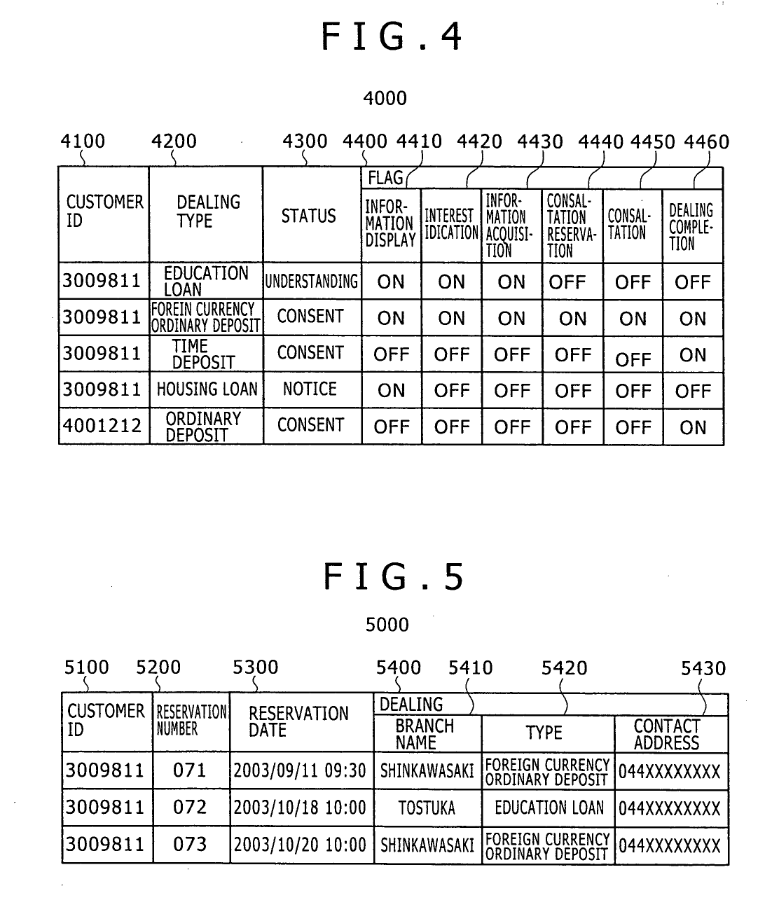

FIG. 4 shows a dealing status table 4000 used to propose commodities suitable for individual customers by managing customers' action histories. It includes major items such as customer ID 4100, dealing type 4200 representative of dealing type, status 4300, and flag 4400. The flag 4400 includes minor items such as information display 4401, interest indication 4402, information acquisition 4403, consultation reservation 4404, consultation 4405, and dealing completion 4406. The status 4300 indicates the degree of customers' interest in and understanding of dealing for each of customers' dealings, and has three types of values, “notice,” “understanding,” and “consent.” The flag 4400 indicates a history of previous actions of a customer on a given commodity or a history of presentation of the commodity to the customer by a sales office. The information display 4401 indicates whether a sales office previously presented a given commodity to a customer. The interest indication 4402 indicates whether a customer was interested in a presented commodity. The information acquisition 4403 indicates whether a customer browsed or acquired detailed information about a given commodity. The consultation reservation 4404 indicates whether a customer reserved consultation on a given commodity. The consultation 4405 indicates whether a customer actually visited the sales office and a bank clerk received consultation on a relevant commodity from the customer. The dealing completion 4406 indicates that a customer purchased a given commodity. Although, in this embodiment, this table is managed by the dealing status control part 131 in the sales office system server 130, by which server it is managed may be freely changed. The flag 4400 of the table may be freely changed in the configuration of its minor items. Specifically, the minor items (information display 4410, etc.) may only define the status 4300. Accordingly, items other than those shown in FIG. 4 may be added, or the items shown may be deleted.

“Notice,” which is a value of the status 4300, indicates that a customer is not interested in a given commodity. For example, to a customer having this status, the sales office presents summary information about the commodity to arouse interest in the commodity.

“Understanding,” which is a value of the status 4300, indicates that a customer is interested in a given commodity. For example, to a customer having this status, the sales office presents detailed information about the commodity to deepen understanding of the commodity.

“Consent,” which is a value of the status 4300, indicates that a customer has deepened understanding of a given commodity to some extent. For example, to a customer having this status, to help the customer to determine whether the commodity is valuable to the customer, the sales office has a consultation about the commodity or presents the result of a simulation on the commodity, based on data of the customer.

In this embodiment, the system manages the degrees of customers' interest in and understanding of commodities by the dealing status table 4000, and proposes a commodity, taking the degrees into account.

FIG. 5 shows a consultation reservation information table 5000 that manages information of consultation reservations made between customers and sales offices, and is used to enable appropriate treatment for customers who visit the sales offices. It includes major items such as customer ID 5100, reservation number 5200, reservation date 5300, and dealing 5400. Furthermore, the dealing 5400 includes minor items such as branch name 5410, type 5420, and contact address 5430. Although, in this embodiment, this table is managed by a consultation reservation information control part 132 in the sales office system server 130, by which server it is managed may be freely changed. The dealing 5400 of the table may be freely changed in the configuration of its minor items.

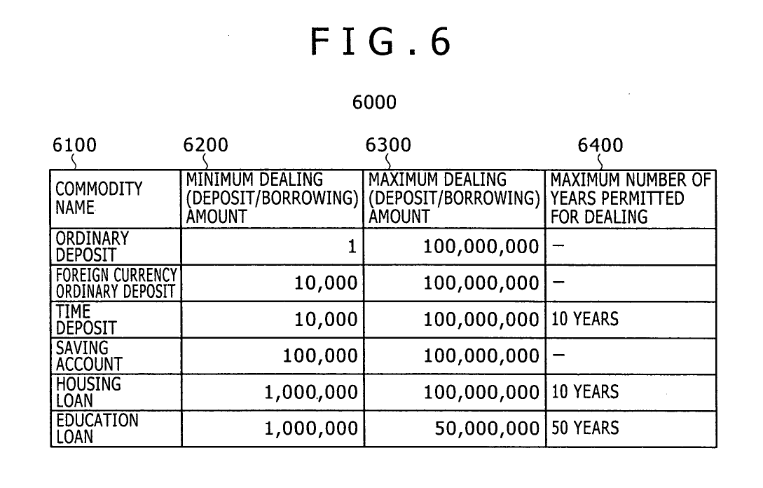

FIG. 6 shows a commodity information table 6000 used to offer commodity information for access from Internet banking and information/consultation terminal 105. It includes commodity name 6100, minimum dealing (deposit/borrowing) amount 6200, maximum dealing (deposit/borrowing) amount 6300, and maximum number of years permitted for dealing 6400. Although, in this embodiment, this table is managed by a commodity information control part 133 in the sales office system server 130, by which server it is managed may be freely changed. Items of this table may be freely changed depending on commodity information required.

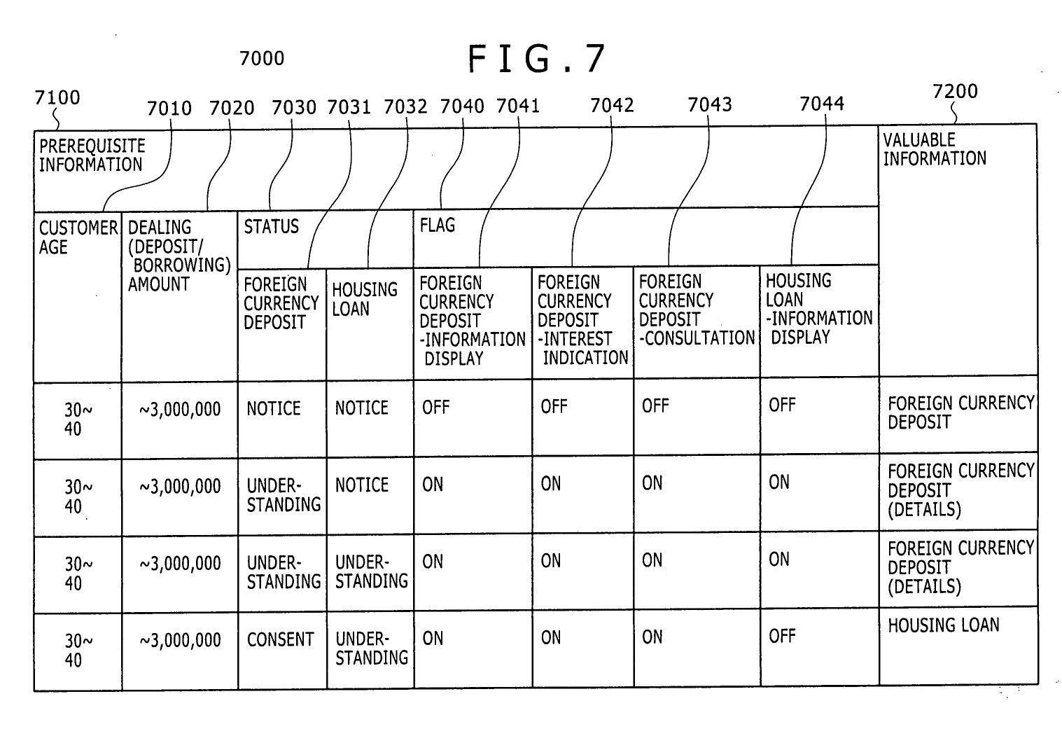

FIG. 7 shows a valuable information criterion table 7000 used to decide commodities to be proposed to individual customers from data held in the customer information table 3000 and the dealing status table 4000. It includes major items such as prerequisite information 7100 and valuable information 7200. Furthermore, the prerequisite information 7100 includes medium items such as customer age 7010, dealing (deposit/borrowing) amount 7020, status 7030, and flag 7040. Furthermore, the status 7030 includes minor items such as foreign currency deposit 7031 and housing loan 7032. The flag includes minor items such as foreign currency deposit—information display 7041, foreign currency deposit—interest indication 7042, foreign currency deposit—consultation 7043, and housing loan—interest indication 7044. The status 7030 is the same as the status 4030 in the dealing status table 4000 shown in FIG. 4. Although, in this embodiment, this table is managed by the valuable information decision part 134 in the sales office system server 130, by which server it is managed may be freely changed. The configuration of the medium items and the minor items of this table may be freely changed.

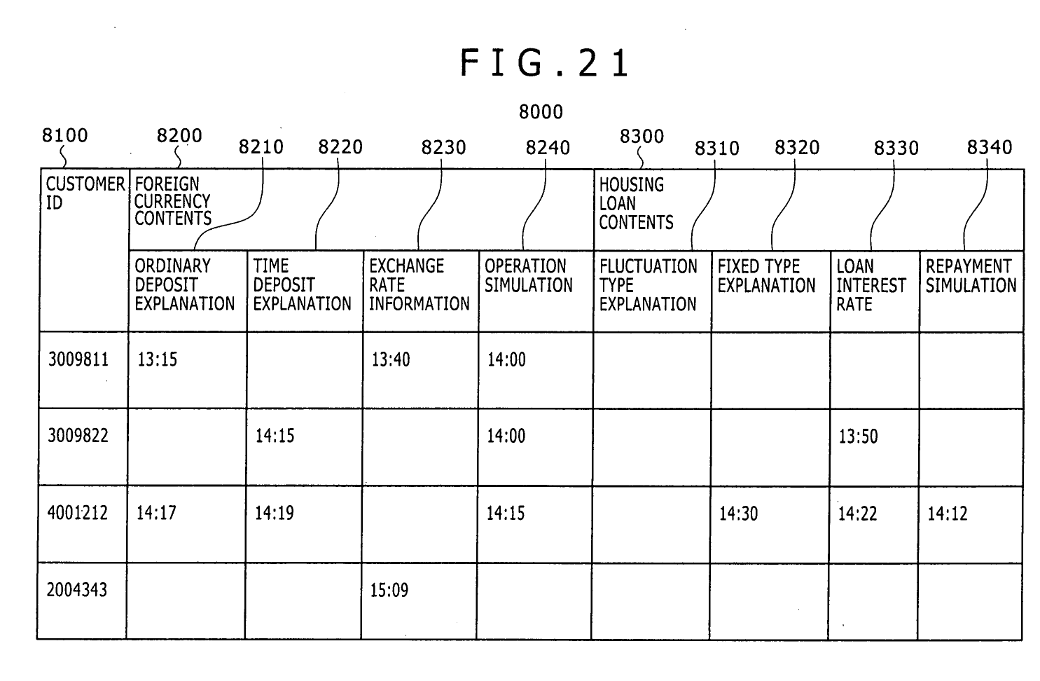

FIG. 21 shows a temporary customer operation history table 8000 that temporarily holds a history of operations on the information/consultation terminal 105 placed in the office. It includes major items such as customer ID 8100, foreign currency deposit contents 8200, and housing loan contents 8300. Furthermore, the foreign currency deposit contents 8200 include minor items such as ordinary deposit explanation 8210, time deposit explanation 8220, market price information 8230, and operation simulation 8240. The housing loan contents 8300 include minor items such as fluctuation type explanation 8310, fixed type explanation 8320, loan interest rate 8330, and repayment simulation 8340. Although, in this embodiment, this table is managed by a temporary customer operation history control part 136 in the sales office system server 130, by which server it is managed may be freely changed. The configuration of the major items except the customer ID 8100 and the minor items of this table may be freely changed.

The temporary customer operation history table 8000 contains temporary data such as operation histories of a specific day. The content of the temporary customer operation history table 8000 is reflected in the dealing status table 4000 according to a certain rule by daily batch processing. However, the present invention does not describe the rule by which the content of the temporary customer operation history table 8000 is reflected in the dealing status table 4000.

In this embodiment, the customer information table for Internet banking 2000, the customer information table 3000, the dealing status table 4000, the consultation reservation information table 5000, the commodity information table 6000, the valuable information criterion table 7000, and the temporary customer operation history table 8000 are managed by the database. They may be managed by any method. The above-mentioned tables are used in this system.

The following describes a processing procedure of the present invention.

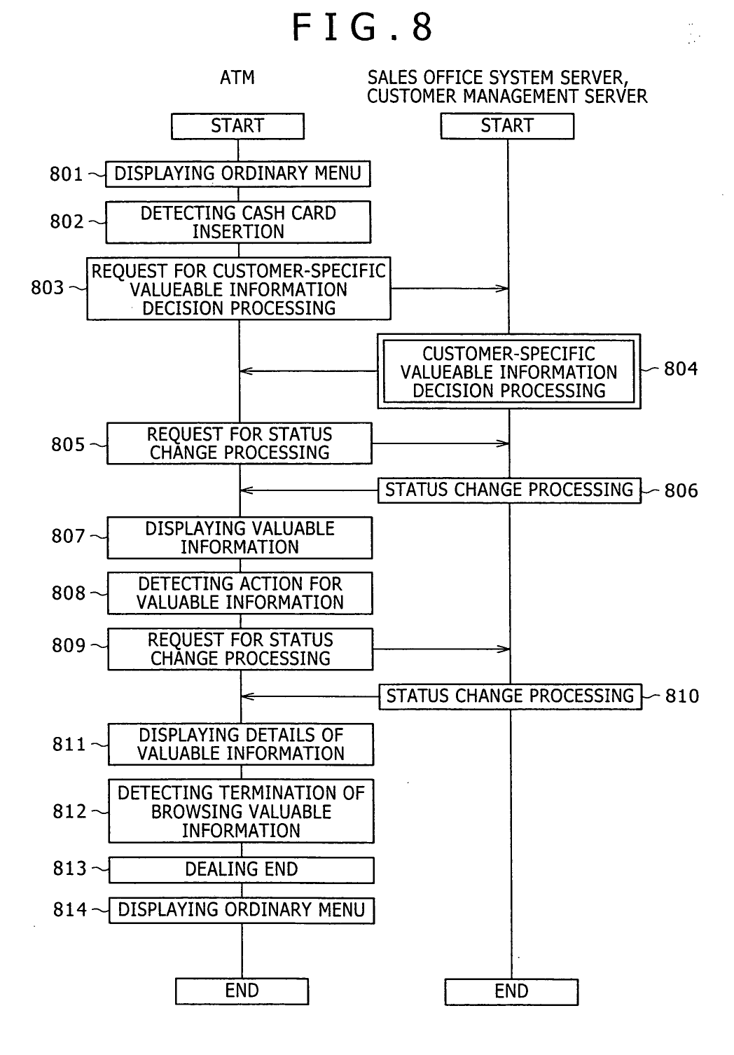

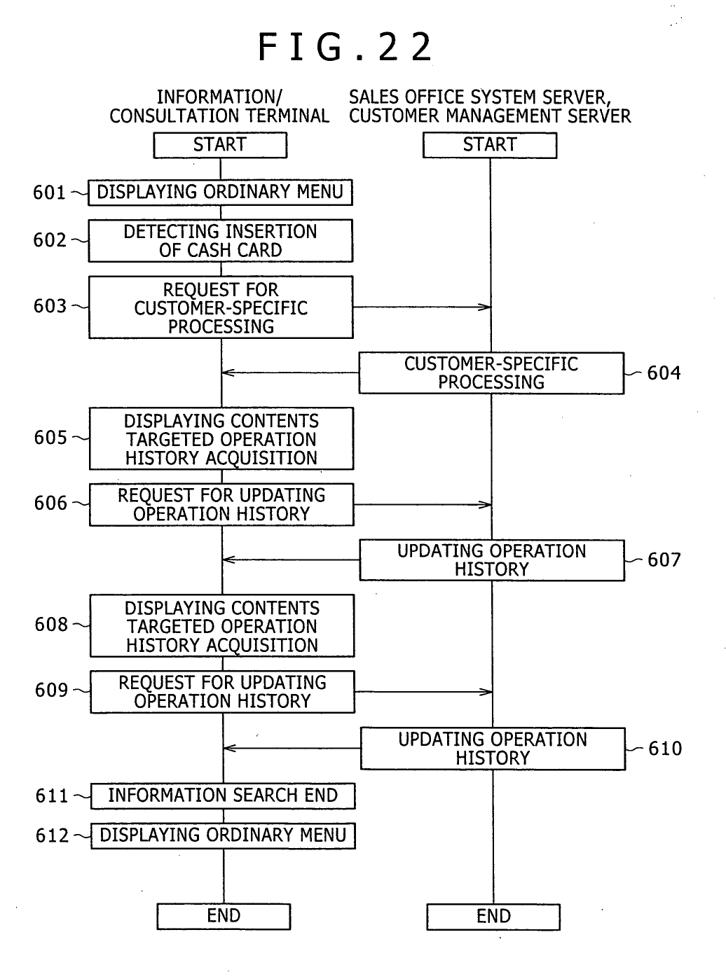

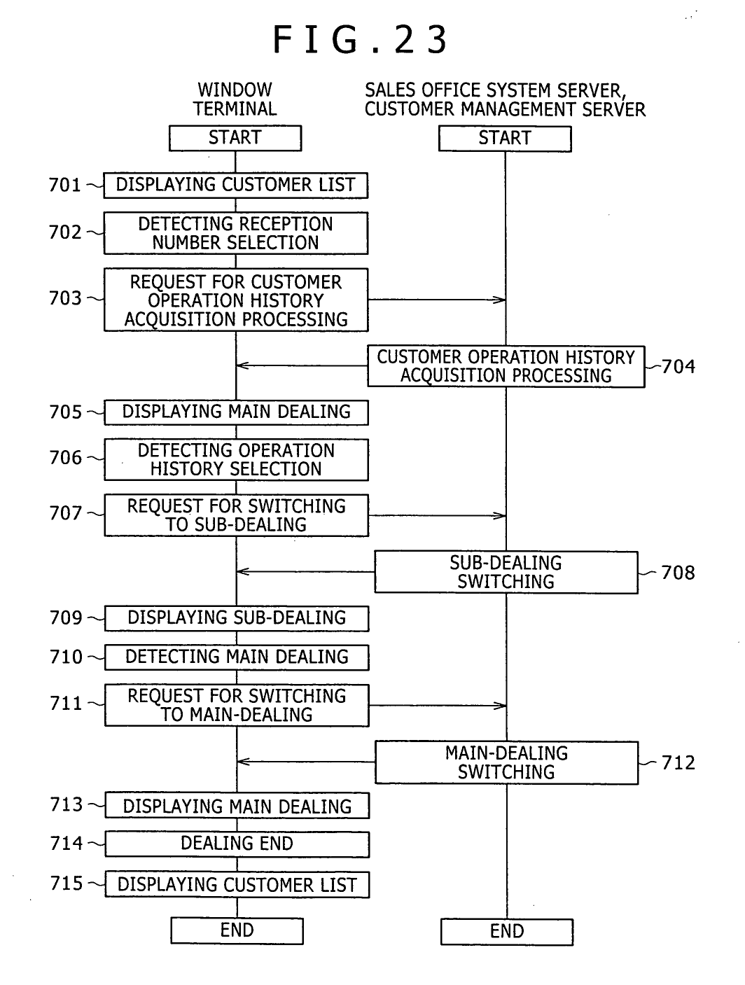

Especially, processing in the ATM 106 and processing in the customer operation type terminal 111 outside the sales office will be described in detail with reference to flowcharts of FIGS. 8 to 10. Processing in the information/consultation terminal 105 and the window terminal 107 in the sales office will be described in detail with reference to flowcharts of FIGS. 22 and 23.

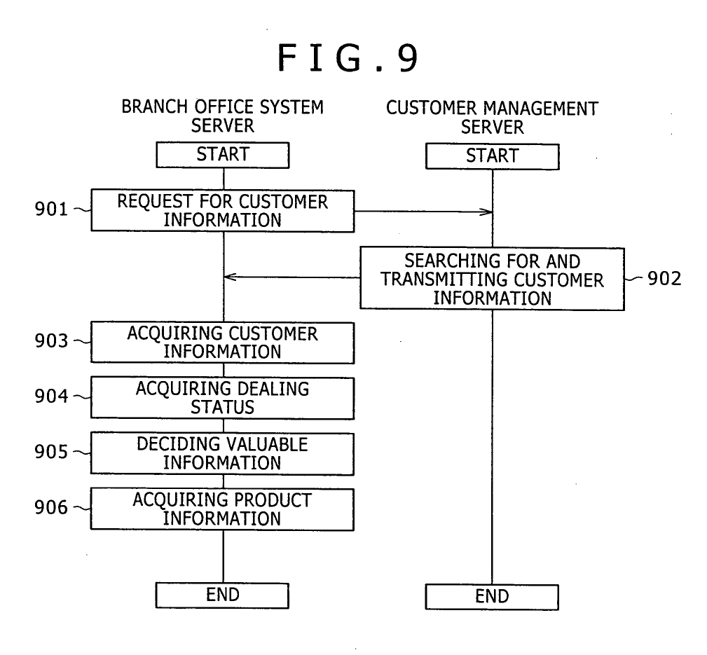

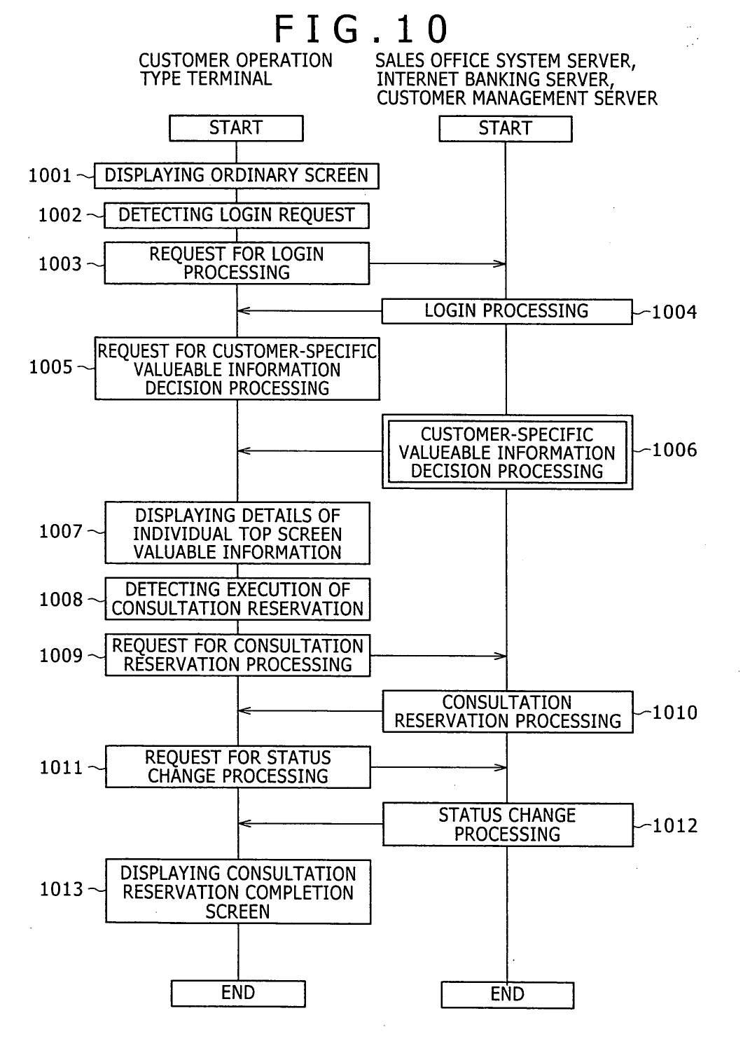

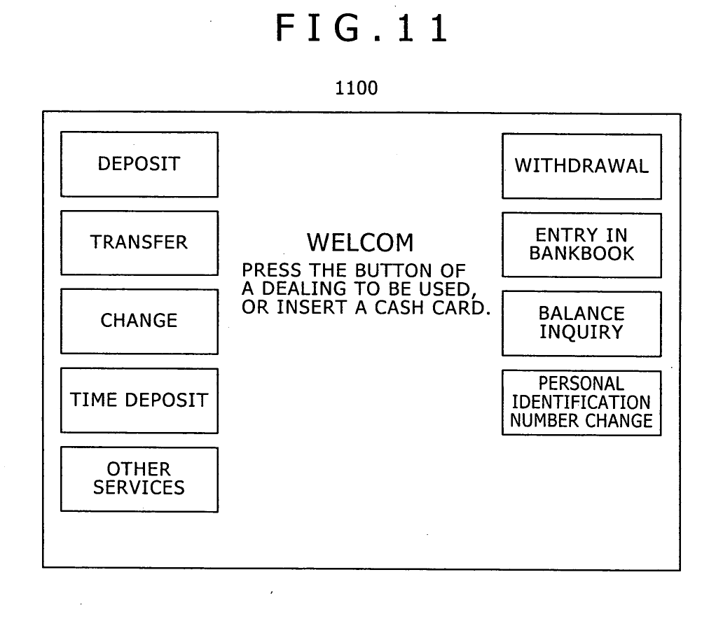

FIG. 8 shows processing in which, when an advertisement has been displayed in the ATM 106, the sales office system server 130 changes the dealing status table 4000 according to a customer's operations. FIG. 9 shows processing in which the sales office system server 130 uses a customer's information to select information valuable to each customer. FIG. 10 shows processing in which, in Internet banking, the sales office system server 130 changes the dealing status table 4000 according to a customer's operations. FIG. 22 shows processing in which the sales office system server updates an operation history according to a customer's operations on the information/consultation terminal 105. FIG. 23 shows processing of switching among the displaying of a customer's history on a window terminal in the sales office system server, a dealing being an initial customer's purpose to visit the sales office, and a dealing interesting to a customer.

Referring to an ATM control flowchart in FIG. 8, a description is made of a procedure of processing from valuable information display by ATM to the updating of the dealing status table 4000. FIG. 8 shows a flow of processing in the ATM 106 and a flow of processing in the sales office system server 130. Examples of screens displayed in the ATM 106 are shown using FIGS. 11 to 14.

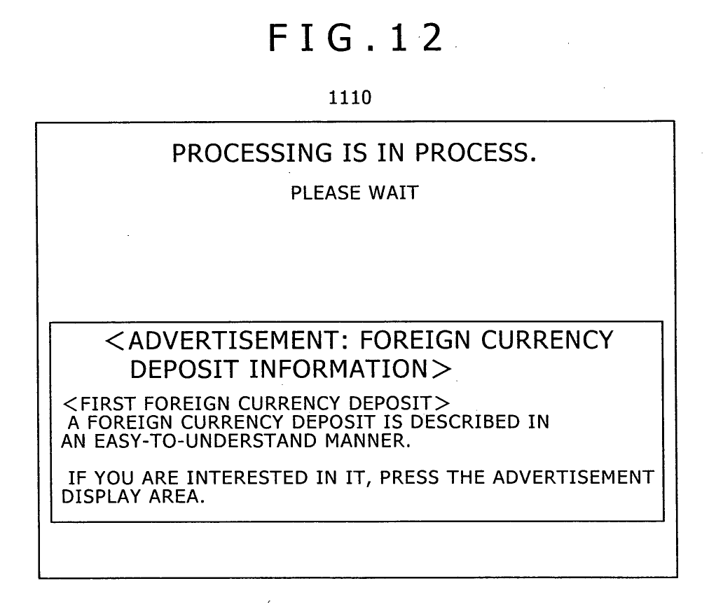

An ATM screen (menu screen) 1100 of FIG. 11 is displayed on a touch panel display of the ATM (Step 801). When a customer who visits the sales office for the purpose of a certain dealing starts the dealing on the ATM 106 and inserts his (her) cash card in the ATM 106, the ATM 106 detects that the cash card has been inserted (Step 802). Based on information of the inserted cash card, the ATM 106 transmits the event code of customer-specific valuable information decision processing that performs acquisition of customer information and selection of valuable information, and the information of the cash card to the sales office system server 130 (Step 803). The sales office system server 130 decides valuable information by the customer-specific valuable information decision processing, and returns the valuable information to the ATM 106 as a processing result (Step 804). The customer-specific valuable information decision processing will be detailed later in FIG. 9. The ATM 106 requests the sales office system server 130 to turn ON the information display flag 4410 on a commodity targeted for the valuable information in the dealing status table 4000 (Step 805). Based on the request from the ATM 106, the sales office system server 130 performs status change processing that changes the contents of status 4300 and flag 4400 for the dealing status table 4000 (Step 806). While waiting for the processing for the dealing, the ATM 106 displays the valuable information specified as a processing result by the sales office system server 130 on an ATM screen (processing screen) 1110 of FIG. 12 as an advertisement (e.g., information about foreign currency deposit) (Step 807).

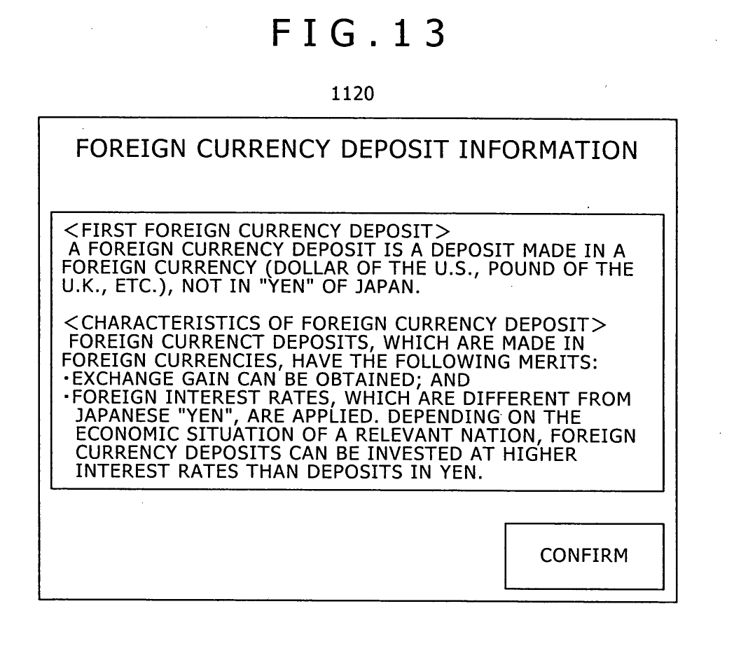

When the customer is interested in the valuable information, and touches a specified part on the touch panel display, the ATM detects the customer's contact with the specified part, and when it does not detect the contact, it keeps displaying the ATM screen (processing screen) 1110 until termination of the dealing (Step 808). When detecting the contact, the ATM 106 transmits, to the sales office system server 130, the event code of status change processing that changes the interest indication 4420 flag and the status 4300 on the commodity in the dealing status table 4000 to “ON” and “Understanding”, respectively (Step 809). Based on the event code from the ATM 106, the sales office system server 130 performs the status change processing for the dealing status table 4000 (Step 810). When detecting the contact, the ATM 106 displays details of the valuable information on the screen like the ATM screen (valuable information display screen) 1120 of FIG. 13, and when processing of the dealing has terminated, displays a message indicating processing completion (Step 811).

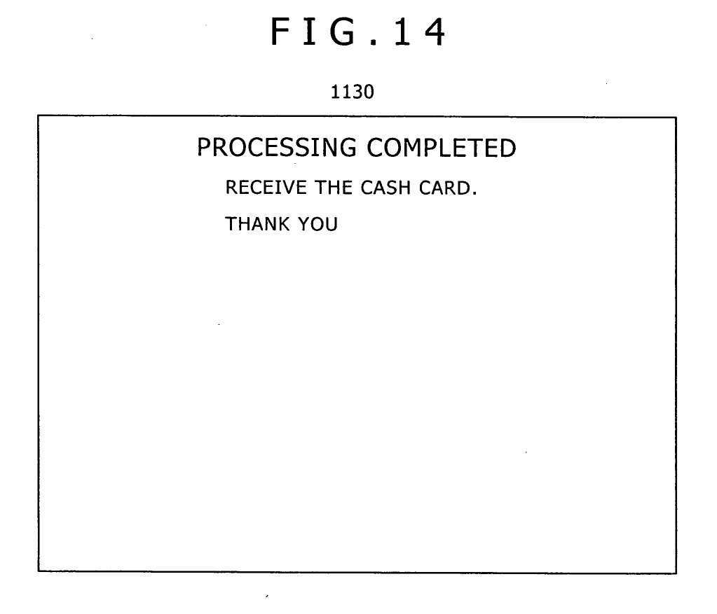

When processing of the dealing terminates, or the customer has read the valuable information details, the customer performs a prescribed procedure for terminating all dealings (pressing of a prescribed button, extraction of the cash card, etc.), and the ATM detects the prescribed procedure (Step 812). The ATM 106 terminates all transactions (Step 813), displays a message indicating processing completion on the screen like an ATM screen 1130 (processing completion screen) of FIG. 14, and then returns to a normal menu display (Step 814).

The above is an explanation of a processing procedure from valuable information display by an ATM to the updating of the dealing status table 4000.

With reference to the customer-specific valuable information decision flowchart of FIG. 9, the following describes a processing procedure of the customer-specific valuable information decision processing (Step 804) in FIG. 8. FIG. 9 separately shows processing in the sales office system server and processing in various servers.

The sales office system server 130 receives the customer-specific valuable information decision processing request, and transmits a customer ID acquired from the cash card to the customer management server 150 to request customer information (Step 901). The customer management server 150 searches the customer information table 3000 based on the received customer ID to acquire the customer information of a corresponding customer, and transmits it to the sales office system server 130 (Step 902). The sales office system server 130 acquires the customer information of the corresponding customer transmitted from the customer management server 150 (Step 903). The sales office system server 130 uses the customer ID of the customer contained in the customer information to acquire a dealing status of the customer from the dealing status table 4000 (Step 904). The sales office system server 130 selects information valuable to the customer by comparing the customer information and the dealing status with those in the valuable information criterion table 7000 (Step 905). In the process of the valuable information decision, a decision with site situations in mind may be included, such as the avoidance of commodity presentation in a season or time zone in which the sales office 100 is crowded. The sales office system server 130 acquires more detailed information from the commodity information table 6000 with respect to information valuable to the customer, and transmits it (Step 906).

The valuable information criterion table 7000 used here is organized so as to select detailed information about commodities represented as “Understanding” in the status 4300 in the dealing status table 4000 with the highest priority, to select summary information about commodities represented as “Notice” in the status 4300 in the dealing status table 4000 with the next highest priority, and avoid the selection of commodity information about commodities represented as “Consent” in the status 4300 in the dealing status table 4000.

The following describes the valuable information decision processing in FIG. 9 based on a more concrete example.

As an example, consider the case where the dealing status table 4000 on the customer indicates “Notice” in the status 4300, and information display 4410 OFF, interest indication 4420 OFF, information acquisition 4430 OFF, consultation reservation 4400 OFF, consultation 4450 OFF, and dealing completion 4460 OFF in the flag 4400. When the customer information table 3000 on the customer indicates 35 as customer age 3300 and 2,000,000 as dealing (deposit/borrowing) amount 3700, foreign currency deposit is selected as valuable information, taking into account the prerequisite information 7100 of the valuable information criterion table 7000.

The above is an explanation of a processing procedure of the customer-specific valuable information decision in FIG. 9.

The following describes a processing procedure of information processors except the ATM 106 in the sales office 100. In this embodiment, an information display unit 103 and an information/consultation terminal 105 are described as examples of information processors in the sales office 100 except the ATM 106.

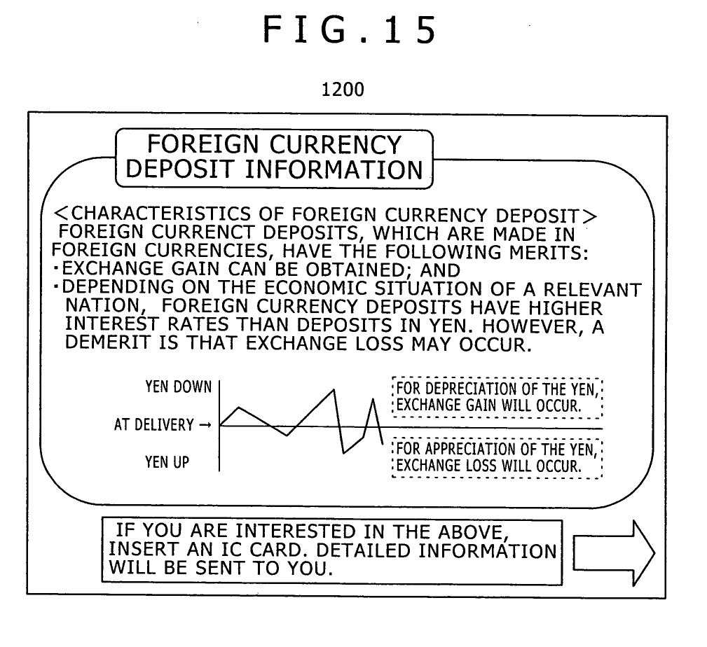

First, the information display unit 103 will be described. The information display unit 103 is a large-scale display placed in the sales office 100. It includes a means for receiving information input over infrared or the like (radio communication is also available) from the portable terminal 101 and the like (e.g., cellular phone and PDA), and a means for reading information from an IC card and the like. The information display unit 103 selects valuable information from information of a customer in the sales office, selects information valuable to a customer at the shortest distance, or selects arbitrary valuable information and displays it on the display like an information display unit screen 1200 of FIG. 15. The specifications of the information display unit 103 such as a customer detection function of the information display unit 103 are out of the scope of the present invention. The customer can capture detailed information about information displayed in the information display unit 103 into the portable terminal 101, or can request the displaying of detailed information by showing the IC card or the like. For the capturing of detailed information or the request of detailed information display by the customer, the system identifies a customer 1D, changes the interest indication 4420 and the information acquisition 4430 of the flag 4400 of the dealing status table 4000 to ON, and changes “Notice” in the status 4300 of the dealing status table 4000, if so, to “Understanding.” Moreover, for the capturing of detailed information or the request of detailed information display by the customer, the system shows the URI of Internet banking and introduces the information processors placed in the sales office to guide the customer to the acquisition of more detailed information about the commodity.

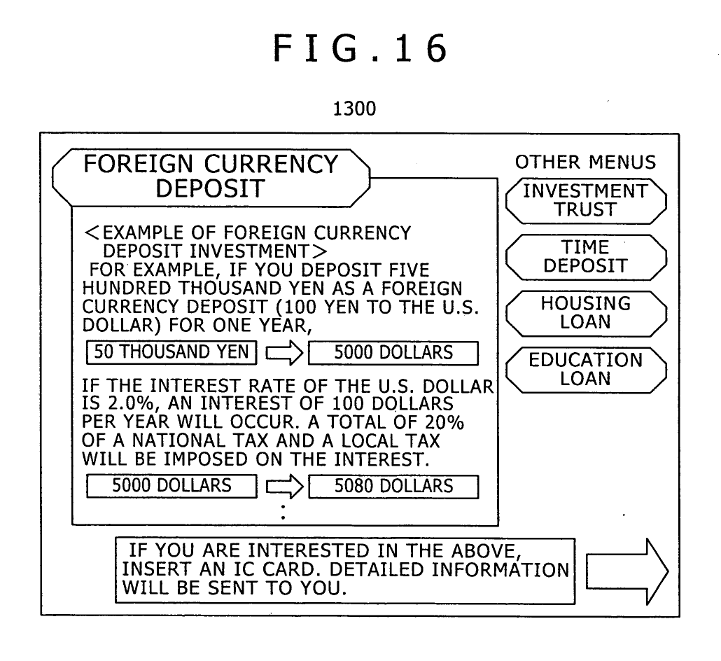

The following describes the information/consultation terminal 105. The information/consultation terminal 105, which is an information processor placed in the sales office 100, permits a customer to search for and browse information about banks and commodities. Unlike the information display unit 103, the information/consultation terminal 105 may be exclusively used by a customer. The information/consultation terminal 105, which includes some customer authentication means, presents information valuable to a customer and changes the dealing status table 4000 according to a customer's operations. The information/consultation terminal screen 1300 of FIG. 16 is shown as an example of the screen of the information/consultation terminal. The specifications of the information/consultation terminal 105 are out of the scope of the present invention. The information/consultation terminal 105, like the information display unit 103, presents a means for conducting consultations about commodities with Internet banking and bank clerks, and a means for obtaining other information according to the dealing status table 4000. By thus managing the degrees of a customers' interest and understanding by the dealing status table 4000, the system can guide customers to information acquisition means judged as appropriate and information processors judged as appropriate.

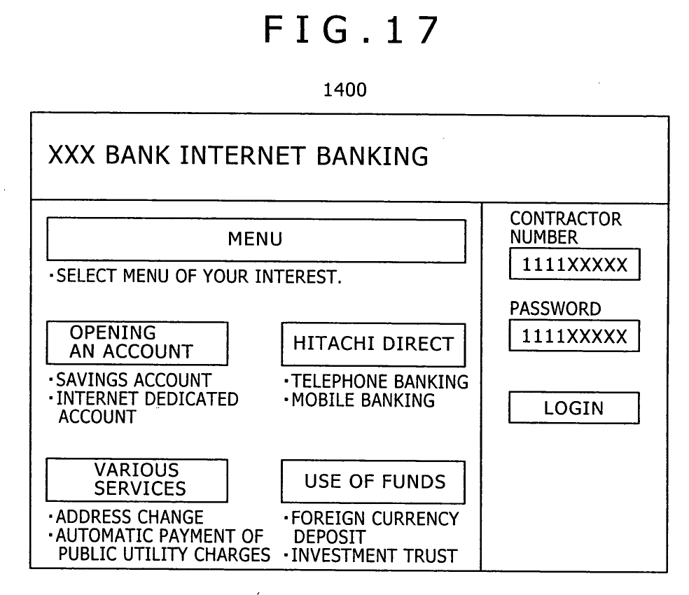

With reference to an Internet banking control flowchart of FIG. 10, the following describes a processing procedure from valuable information detailed display to consultation reservation after a login operation in Internet banking by the customer operation type terminal 111 (e.g., private personal computer and the like placed at home). FIG. 10 shows a processing flow in the customer operation type terminal 111 and a processing flow in the sales office system server 130. Examples of screens displayed in the customer operation type terminal 111 are shown using FIGS. 17 to 20.

An Internet banking screen 1400 of FIG. 17 (menu screen) is displayed in the display of the customer operation type terminal 111 (Step 1001). The customer inputs an Internet banking ID and an Internet banking password to specified fields in the screen, and presses the login button. On detecting that the login button has been pressed, the customer operation type terminal 111 acquires the Internet banking ID and the Internet banking password (Step 1002). The customer operation type terminal 111 requests login processing by transmitting the event code of login processing, the Internet banking ID, and the Internet banking password to the sales office system server 130 (Step 1003). The sales office system server 130 requests login processing by transmitting the event code of login processing, the Internet banking ID, and the Internet banking password to the Internet banking server 140. The Internet banking server 140 performs login processing using the event code of the login processing, the Internet banking ID, and the Internet banking password. By matching the Internet banking ID with the customer information table 3000 for Internet banking, the Internet banking server 140 authenticates the customer, obtains the customer ID of the customer, and transmits it to the sales office system server 130 along with the event code of login completion. On receiving the event code of login completion and the customer ID, the sales office system server 130 transmits the event code of login completion and the customer ID to the customer operation type terminal 111 (Step 1004). Based on the received customer ID, the customer operation type terminal 111 transmits the event code of customer-specific valuable information decision processing and the customer ID to the sales office system server 130 (Step 1005). The sales office system server 130 decides valuable information by the customer-specific valuable information decision processing, and returns it to the customer operation type terminal 111 as a processing result (Step 1006). A processing procedure of the customer-specific valuable information decision processing (Step 1006) in FIG. 10 is the same as that of the customer-specific valuable information decision processing (Step 804) in FIG. 8.

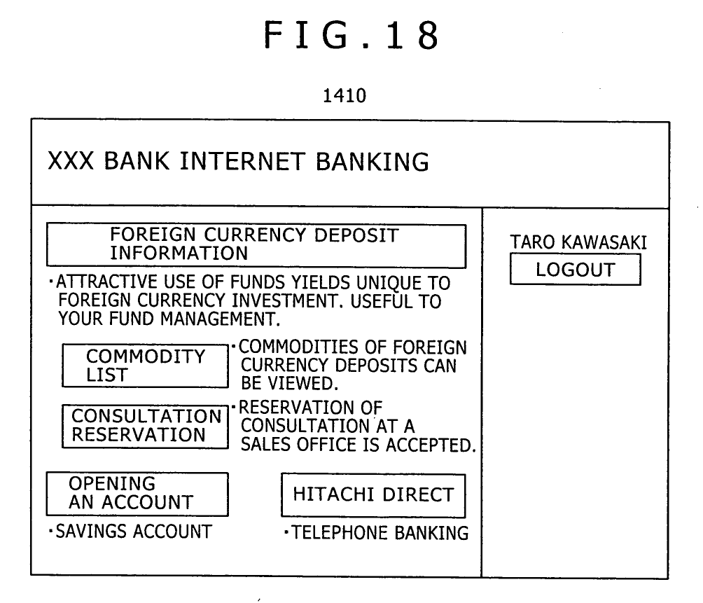

The customer operation type terminal 111 displays the Internet banking screen 1410 of FIG. 18 (customer top screen). The valuable information is displayed on the screen (e.g., detailed information about foreign currency deposits) (Step 1007).

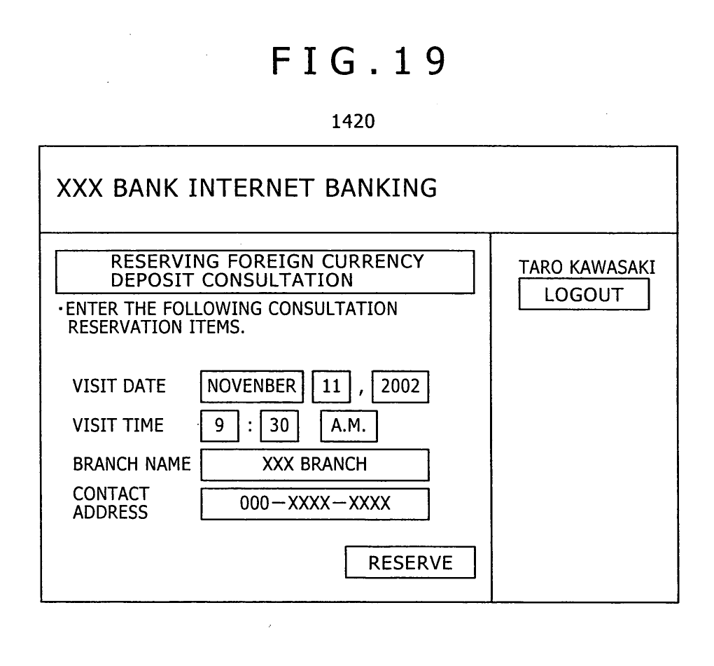

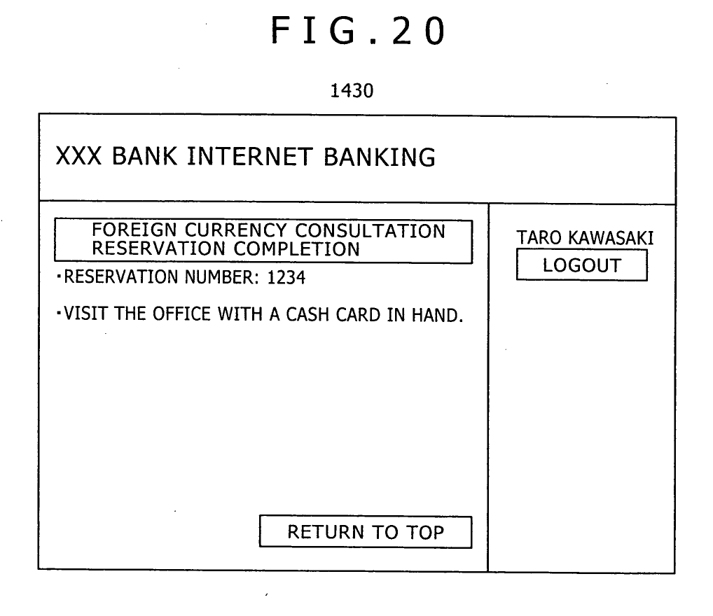

The Internet banking has a function to reserve consultation about commodities with a bank clerk. A customer who acquired information about a commodity by various means and deepened understanding of the commodity can make a reservation for consultation with a bank clerk by the consultation reservation function if he (she) desires. The customer moves to an Internet banking screen 1420 of FIG. 19 (consultation reservation screen), and executes a consultation reservation after entering required items. The customer operation type terminal 111 detects the execution of the consultation reservation (Step 1008). The customer operation type terminal 111 requests the execution of the consultation reservation by transmitting the event code of consultation reservation execution and the content of the consultation reservation to the sales office system server 130 (Step 1009). The sales office system server 130 adds the consultation reservation to the consultation reservation information table 5000, and transmits the event code of consultation reservation execution completion to the customer operation type terminal 111 (Step 1010). On receiving the event code of consultation reservation completion, the customer operation type terminal 111 requests the sales office system server 130 to turn on the consultation reservation flag 4440 in the dealing status table 4000 with respect to the commodity targeted for the consultation reservation and change the status 4300 of the commodity in the dealing status table 4000 to “Consent” (Step 1011). According to the request from the customer operation type terminal 111, the sales office system server 130 performs status change processing for the dealing status table 4000 (Step 1012). The customer operation type terminal 111 displays the Internet banking screen of FIG. 20 (consultation reservation completion screen) to show the customer the completion of application for consultation reservation) (Step 1013).

The above is an explanation of a processing procedure from valuable information detailed display to consultation reservation after a login operation in Internet banking by the customer operation type terminal 111.

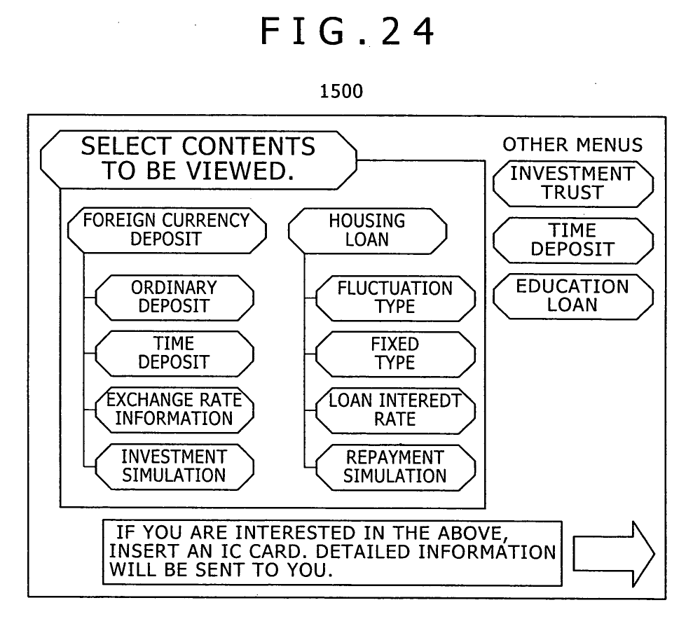

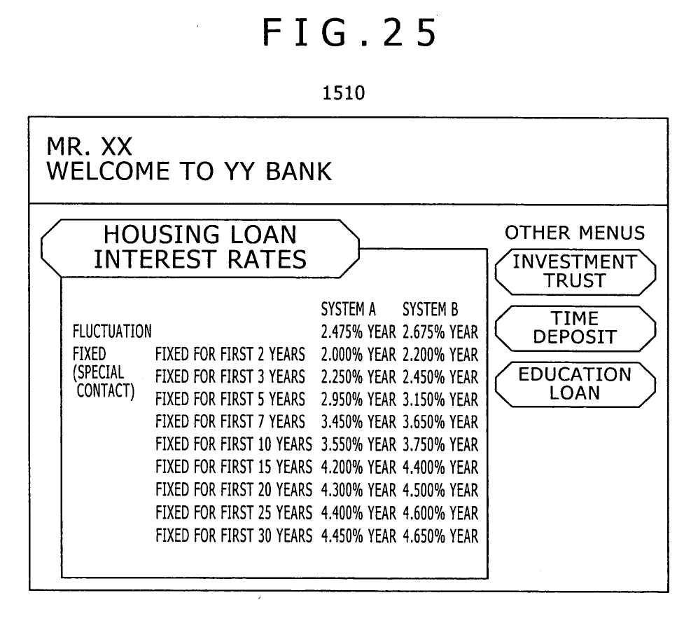

With reference to an information/consultation terminal flowchart of FIG. 22, the following describes a processing procedure for acquiring a customer's operation history accompanying a customer's information search by the information/consultation terminal 105. The processing of deciding and displaying a customer's valuable information, which has already been described (Steps 801 to 807), is omitted in this processing procedure. FIG. 22 shows the flow of processing in the information/consultation terminal 105 and the flow of processing in the sales office system server 130. Examples of screens displayed in the information/consultation terminal 105 will be shown using FIGS. 24 and 25.

An information/consultation terminal screen 1500 of FIG. 24 (menu screen) is displayed on the screen of the information/consultation terminal 105 (Step 601). When a customer who visits the information/consultation terminal 105 for the purpose of information search inserts his (her) cash card in the Information/consultation terminal 105 to search for information more suitable to him (her) by using his (her) personal information stored in the sales office system, the information/consultation terminal 105 detects that the cash card has been inserted (Step 602). According to information of the inserted cash card, the information/consultation terminal 105 transmits the event code of customer specific processing that performs the acquisition of customer information and information of the cash card to the sales office system server 130 (Step 603). The sales office system server 130 returns the result of the customer specific processing to the information/consultation terminal 105 (Step 604). When the information/consultation terminal 105 displays on the screen the contents targeted for operation history acquisition by a customer's operation like an information/consultation terminal screen 1510 (loan interest rate screen) of FIG. 25 (Step 605), it transmits the event code of operation record updating that registers and updates a operation history, the ID of display contents, information about the customer, and present time to the sales office system server 130 (Step 606). Contents targeted for operation record acquisition may be specific contents or all contents. According to the request from the information/consultation terminal 105, the sales office system server 130 updates the content of the temporary customer operation history table 8000 (Step 607). Each time the information/consultation terminal 105 displays contents targeted for operation history acquisition, the same operation history updating is performed (Steps 608 to 610).

Upon termination of the information search, the customer performs a prescribed procedure (pressing of prescribed buttons, extraction of the cash card, etc.) for terminating the information search processing, and the information/consultation terminal 105 detects the prescribed procedure (Step 611). The information/consultation terminal 105 terminates the dealing (Step 612), and displays the information/consultation terminal screen 1500 of FIG. 24 (menu screen).

The above is an explanation of a processing procedure for acquiring a customer's operation history accompanying the customer's information search by the information/consultation terminal 105.

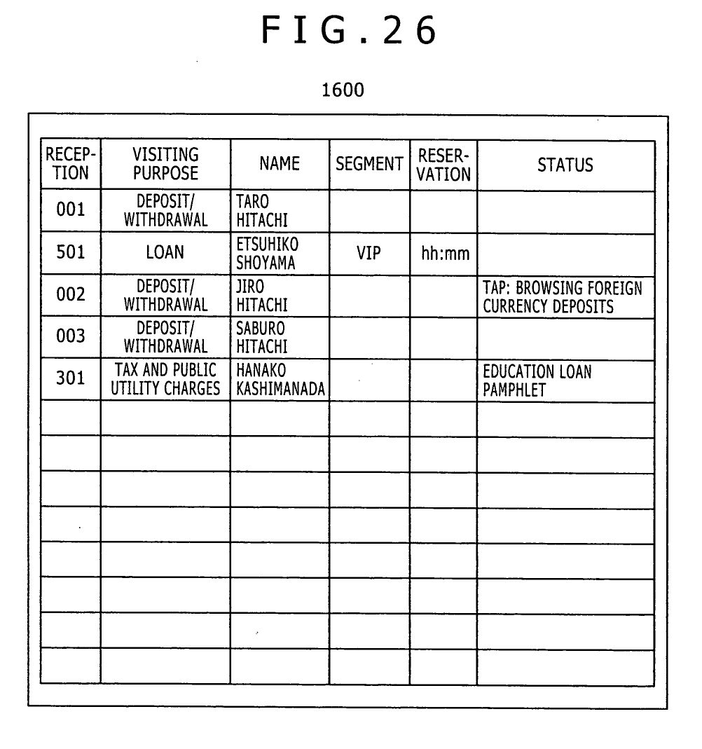

With reference to a window terminal flowchart of FIG. 23, the following describes a processing procedure for dealing switching in customer support at a window by the window terminal 107. FIG. 23 shows the flow of processing in the window terminal 107 and the flow of processing in the sales office system server 130. Examples of screens displayed in the ATM 106 are shown using FIGS. 26 to 28.

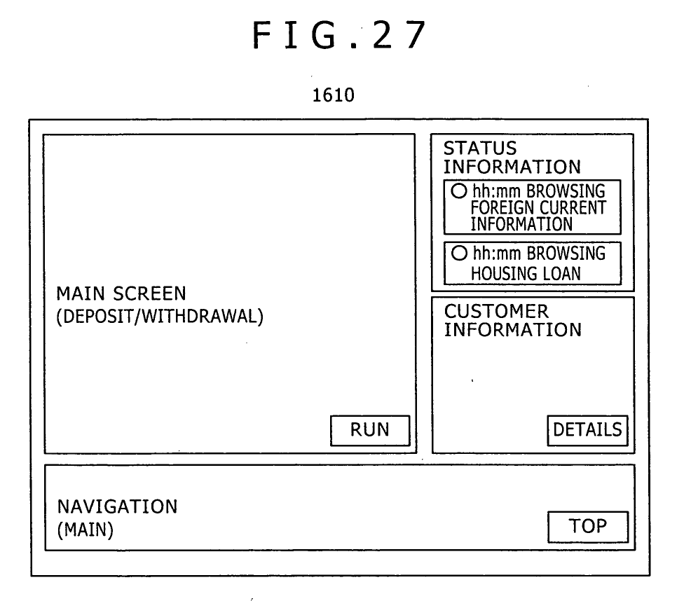

A window terminal screen 1600 of FIG. 26 (customer list screen) is displayed on the screen of the window terminal 107 (Step 701). When the office clerk has selected a reception number of a customer who starts window dealing, the window terminal 107 detects that the reception number has been selected (Step 702). The window terminal 107 transmits the reception number and the event code of customer operation history acquisition processing that acquires a customer's operation history to the sales office system server 130 (Step 703). The sales office system server acquires the customer's operation history from the temporary customer operation history table 8000 by the customer operation history acquisition processing, and returns the operation history to the window terminal 107 as a processing result (Step 704). The window terminal 107 displays a main dealing screen in a form that includes a customer's operation history as the customer's status information, as shown in a window terminal screen 1610 (main dealing screen) of FIG. 27 (Step 705). A dealing being an initial purpose of the customer is referred to as a main dealing, and a dealing that an office clerk performs sales based on a customer's operation history is referred to as a sub-dealing.

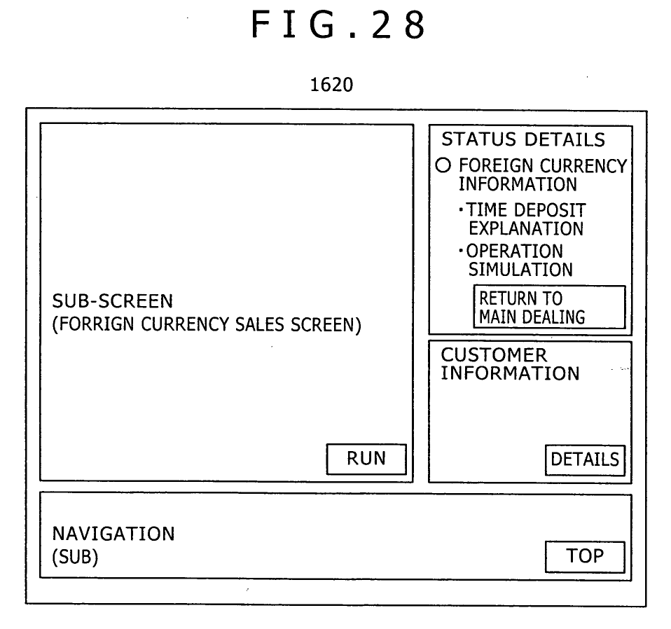

When the office clerk, during a window dealing with the customer, senses the customer's interest in a commodity on the operation history, if the clerk selects an operation history button in the course of the main dealing or after its completion, the window terminal 107 detects that operation history has been selected (Step 706). The window terminal 107 transmits the event code of sub-dealing switching processing to the sales office system server 130 (Step 707). According to the request from the window terminal 107, the sales office system server 130 switches dealing processing from the main dealing to a sub-dealing corresponding to the selected operation history, and transmits information of the sub-dealing to the window terminal 107. In this case, if processing for the main dealing is in progress, the sales office system server 130 temporarily saves a content being processed in the main dealing (Step 708). The window terminal 107 displays a sub-dealing screen as the customer's status details in a form that includes the customer's operation history details, as shown in a window terminal screen 1620 of FIG. 28 (sub-dealing screen) (Step 709). The window terminal 107 selects “Return to the main dealing,” or detects completion of the sub-dealing (Step 710). The window terminal 107 transmits the event code of main dealing switching processing to the sales office system server 130 (Step 711). According to the request from the window terminal 107, the sales office system server 130 switches dealing processing from the sub-dealing to the main dealing. In this case, when processing of the main dealing is completed, all dealings are terminated, but if the main dealing is in the course of processing, the sales office system server acquires a content being processed in the main dealing and transmits it to the window terminal 107 (Step 712). If the main dealing is in the course of processing, the window terminal 107 displays the main dealing screen like Step 705 (Step 713).

Upon termination of the main dealing, the office clerk performs a prescribed procedure (pressing of prescribed buttons, etc.) for terminating all dealings, and the window terminal 107 detects the prescribed procedure (Step 714). The window terminal 107 terminates all dealings, and displays the window terminal screen 1600 of FIG. 26 (customer list screen) (Step 715).

The above is an explanation of a processing procedure for dealing switching in customer support at a window by the window terminal 107.

Hereinbefore, although the present invention has been described in detail based on the preferred embodiments, the present invention is not limited to the preferred embodiments, but may be modified in various ways without changing the main purports of the present invention.

What is claimed is:

1. A sales office system that supports commodity dealings, and connects with a plurality of information processors via networks, comprising:
storage devices that store information;
connecting devices connected with the networks; and
processors, connected with the connecting devices and the storage devices, that execute the processes of:
presenting summary information describing a summary of a commodity to a purchaser of the commodity via information processors;
accepting input from the purchaser in response to the presented summary information;
storing an identifier for identifying the purchaser and a flag indicating that the purchaser noticed the commodity in the storage devices with a correspondence between them;
presenting detailed information of the commodity to the purchaser in response to the input from the purchaser;
accepting, from the purchaser, input of consideration to purchasing a commodity;
storing the identifier and a consideration flag indicating the consideration in the storage devices with a correspondence between them; and
thereby advising a purchaser marked with the consideration flag to purchase the commodity.

2. The sales office system according to claim 1,
wherein the processors present detailed information about a commodity inputted as consideration to the purchaser.

3. The sales office system according to claim 1,
wherein the processors classificationally manages statuses of commodity purchase according to storage contents in the storage devices, and presents information about commodities corresponding to the classified statuses.

4. The sales office system according to claim 1,
wherein the processors store an input history of the consideration in the storage devices.

5. The sales office system according to claim 1,
wherein the processors present the input history of the consideration in response to a request from office clerks.

6. The sales office system according to claim 5,
wherein the processors, in a scene in which a dealing of the purchaser is processed by an office clerk, switch between the dealing and a dealing of the commodity under consideration according to input of the office clerk.

7. An information management method using a sales office system that supports commodity dealings, and connects with a plurality of information processors via networks, the information management method comprising the steps of:
presenting summary information describing a summary of a commodity to a purchaser of the commodity via information processors;
accepting input from the purchaser in response to the presented summary information;
storing an identifier for identifying the purchaser and a flag indicating that the purchaser noticed the commodity with a correspondence between them;
presenting detailed information of the commodity to the purchaser in response to the input from the purchaser;
accepting, from the purchaser, input of consideration to purchasing a commodity;
storing the identifier and a consideration flag indicating the consideration with a correspondence between them; and
thereby advising a purchaser marked with the consideration flag to purchase the commodity.

8. The information management method using the sales office system according to claim 7,
wherein detailed information about a commodity inputted as consideration is presented to the purchaser.

9. The information management method using the sales office system according to claim 7, further comprising the steps of:
classificationally managing statuses of commodity purchase according to storage by means for storing the flag in association and storage by means for storing the purchase consideration flag in association; and
presenting information about commodities corresponding to the classified statuses.

10. The information management method using the sales office system according to claim 7, further comprising the step of storing an input history of the consideration.

11. The information management method using the sales office system according to claim 7, further comprising the step of referring to the input history of the consideration by office clerks.

12. The information management method using the sales office system according to claim 7, further comprising the step of, in a scene in which a dealing of the purchaser is processed by an office clerk, switching between the dealing and a dealing of the commodity under consideration by judgment of the office clerk.

13. A sales office system that supports commodity dealings, and connects with a plurality of information processors via networks, comprising:
means for presenting summary information describing a summary of a commodity to a purchaser of the commodity via information processors;
means for accepting input from the purchaser in response to the presented summary information;
means for storing an identifier for identifying the purchaser and a flag indicating that the purchaser noticed the commodity with a correspondence between them;
means for presenting detailed information of the commodity to the purchaser in response to the input from the purchaser;
means for accepting, from the purchaser, input of consideration to purchasing a commodity; and
means for storing the identifier and a consideration flag indicating the consideration with a correspondence between them,
thereby advising a purchaser marked with the consideration flag to purchase the commodity.

14. The sales office system according to claim 13, further comprising means for presenting detailed information about a commodity inputted as consideration to the purchaser.

15. The sales office system according to claim 13, further comprising:
means for classificationally managing statuses of commodity purchase according to storage by means for storing the flag in association and storage by means for storing the purchase consideration flag in association; and
means for presenting information about commodities corresponding to the classified statuses.

16. The sales office system according to claim 13, further comprising means for storing an input history of the consideration.

17. The sales office system according to claim 15, further comprising means by which office clerks refer to the input history of the consideration.

18. The sales office system according to claim 17, further comprising means for, in a scene in which a dealing of the purchaser is processed by an office clerk, switching between the dealing and a dealing of the commodity under consideration by judgment of the office clerk.
